(19) United States
(12) Patent Application Publication
(10) Pub. No.: US 2008/0192295 A1
(43) Pub. Date: Aug. 14, 2008

(54) Generation of Areas of Position Location Pattern

(75) Inventors: Manuel Gonzalez, Malaga (ES); Manuel Angel Albarran Moyo, Barcelona (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/587,494

(22) PCT Filed: Jun. 7, 2005
(86) PCT No.: PCT/EP05/52609

§ 371 Date: Nov. 21, 2007

(30) Foreign Application Priority Data
Jun. 16, 2004 (GB) 04113466.4

(51) Int. Cl. G06F 15/00

(52) U.S. Cl. 358/1.16

(57) ABSTRACT

A method of generating an area of location pattern, the area comprising a plurality of sub-areas, the method comprising: for each of the sub-areas, determining (a) metadata identifying the sub-area, and (b) the position of the sub-area relative to the area; transmitting to a receiving device (a) and (b) for each of the sub-areas; retrieving from memory, associated with the receiving device, image information corresponding to the metadata, thereby generating in memory an image corresponding to the area of the pattern to be generated.

### FIELD OF THE INVENTION

This invention relates to the generation of areas of position location pattern, in particular but not exclusively, it relates to the generation of a relatively small area of position location pattern which corresponds to a portion of an existing, larger area of position location pattern.

### BACKGROUND OF THE INVENTION

The printing of optical position location patterns and subsequently reading those patterns with an optical device, such as a digital pen, is known. Typically, only a small portion of a much larger optical pattern is printed at any one time.

In certain known systems a large optical pattern is stored in a centralised database. When a user of the system wishes to print a portion of this pattern, a portion may be allocated to the user by the centralised database. This portion may be transmitted over a network from the centralised database to a personal computer of the user. In such a system the portion of pattern may then be sent in bitmap format to a suitable printer to be printed. The location pattern is typically sent in the form of a print file which also contains human readable content, such that when printed the location pattern and the human readable content are superimposed on the printed document. Such a printed document could be, for example, a form which a user could fill out with a pen.

The file size of such print files is generally very large and causes a reduction in the speed with files are printed. This is largely due the location pattern. Typically, a location pattern of sufficient size to cover one printed A4 page of may require approximately 3 Mb of storage space.

Clearly, where many such files are to be printed, large files are sent to the printer or printers concerned. This situation may commonly arise where it is required to print many copies of a given form each with different position location pattern. The generation, transmission and processing of such large quantities of data can cause various problems in the computers, printers and networks involved. These may simply result in the slowing of the printing and other processes. Additionally, they may even cause elements of the network to crash due to data overload.

It is also known to use offset printing to generate position location pattern but this is relatively inflexible. Using offset printing, a great deal of time is required in setting up the press for printing each page. Because of this the position location pattern printed this way may not be printable on demand, thus necessitating the storing of pre-printed sheets bearing position location pattern. Thus, modifications to the human readable content which is superimposed with position location pattern cannot be readily made.

### SUMMARY OF THE INVENTION

In one aspect of the present invention there is provided a method of generating an area of location pattern, the area comprising a plurality of sub-areas, the method comprising: for each of the sub-areas, determining (a) metadata identifying the sub-area, and (b) the relative position of the sub-area in the area; transmitting to a receiving device (a) and (b) for each of the sub-areas; retrieving from memory, associated with the receiving device, image information corresponding to the metadata, thereby generating in memory an image corresponding to the area of the pattern to be generated.

By transmitting metadata defining areas of the pattern, instead of a graphical representation of the pattern itself, the size of the transmitted file may be significantly reduced. This may significantly reduce the quantity of data which needs to be sent and consequently avoid problems associated with the prior art.

By metadata it is meant any data or information which may be used to identify or reference a sub-area. Such data may take the form of a code, in binary from example.

In embodiments of the present invention, the sub-areas may be arbitrarily determined. However, in preferred embodiments, such sub-areas may be selected such that the position location pattern held in the sub-areas is frequently occurring in the position location pattern as a whole. In this manner, the number of different types of sub-area required in order to reconstruct a portion of a pattern may be reduced. It will be appreciated that in certain position location patterns a certain number of different possible sub-areas, or types of sub-areas, is needed in order that any portion of the pattern as a whole may be reproduced by the recombination of such sub-areas. In preferred embodiments, such a “set” or “complete set” of sub-areas is provided.

In one embodiment, a PC sends such metadata to a printer in order that the printer may print a hard copy of the portion of the digital pattern. In another embodiment, one computer device, for example a server, may send such metadata to another computer device, such as a PC. The PC may then generate the portion of the digital pattern in order to be displayed, for example.

In one embodiment, a printer is arranged to generate the portion of the digital pattern from font characters which have been designed to correspond to known, different areas of a digital pattern. Such font characters may be stored as a font definition file, resident on the printer.

According to another aspect of the invention there is provided a font definition file made up of font characters, corresponding to different areas of a digital pattern.

According to another aspect of the invention there is provided a printer with such a font definition file resident.

According to another aspect of the invention there is provided a data structure made up of predefined image portions and corresponding reference codes, the predefined image portions corresponding to different arrangements of elements making up a position location pattern.

According to other aspects of the invention there is provided a hardware device such as a PC, or a software device such as a printer driver, arranged to generate from a portion of digital pattern a print file comprising a short-hand definition of a portion of the digital pattern, the definition comprising a plurality of codes from which different sub-portions of the pattern can be identified.

According to another aspect of the invention there is provided a hardware device such as a PC or printer arranged to recreate a portion of digital pattern from a print file comprising a short-hand definition of portion of the digital pattern, the device being arranged to retrieve from memory a plurality of predefined sub-portions of the pattern from memory in accordance with the short-hand definition.

The present invention also extends to: computer programs arranged to implement the different methods of the present invention. For example the computer programs run by a device or entity generating or sending the metadata or an associated file on the one hand, and on the other computer programs run by a device or entity receiving the metadata for re-generating or printing a portion of pattern having received the metadata.

Other aspects and advantages of the present invention will be apparent from the following detailed description, together with the accompanying drawings.

### BRIEF DESCRIPTION OF THE DRAWINGS

The invention will now be described, by way of example only, with reference to the accompanying drawings, in which:

FIG. 1 is a representation of a position location pattern of the prior art;

FIG. 2 is a further representation of the position location pattern of FIG. 1, illustrating how elements of the pattern may be conceptually grouped according to one embodiment of the invention;

FIG. 3 is a representation of a system according to one embodiment of the present invention;

FIG. 4 is a representation of a method of printing a position location pattern according to one embodiment of the present invention;

FIGS. 5a-c are schematic illustrations of processing steps carried out on allocated digital pattern according to one embodiment of the present invention;

FIG. 6 is a schematic representation of a look up table used in generating metadata according to one embodiment of the present invention;

FIG. 7 is a block diagram illustrating the merging of position pattern metadata with a document file and subsequent translation into a printer language, as implemented in one embodiment of the present invention;

FIG. 8 is a schematic representation of a page description language file incorporating position pattern metadata employed in one embodiment of the present invention; and,

FIG. 9 is a schematic representation of a font definition file for a “position location pattern font” according to an embodiment of the present invention.

### DESCRIPTION OF PREFERRED EMBODIMENTS

It is convenient to discuss the invention by referring to the prior art Anoto™ digital pen and paper system, but it will be appreciated that the invention is not restricted to use with any proprietary system.

The prior art Anoto™ system is described on their website www.anotofunctionality.com. However, since the content of websites can change with time it is to be made clear that the prior art admitted is that which was published on their website no later than the day before the priority date of this patent application. It is also appropriate to include in this application itself a brief review of the Anoto™ system.

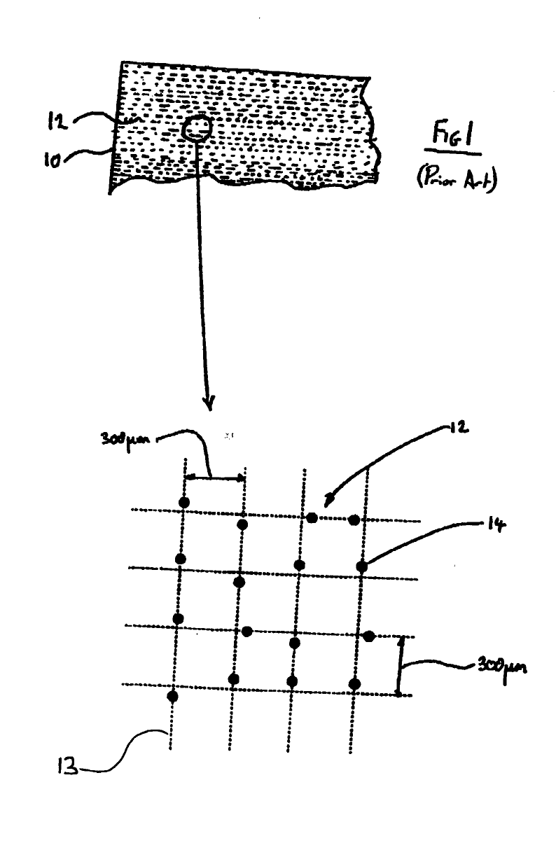

FIG. 1 shows schematically part of an A4 sheet 10 of Anoto™ digital paper. This comprises a part of a very large non-repeating pattern 12 of dots 14. The overall pattern is large enough to cover 60,000,000 square kilometres. The pattern 12 is made from the dots which are printed using infra-red absorbing black ink. The sheet 12 has a pale grey appearance due to the dots 14. The dots 14 are spaced by a nominal spacing of about 300 μm, but are offset from their nominal position a little way (about 50 μm), for example north, south, east or west, from the nominal position. The nominal spacings in both the horizontal and vertical directions form a grid 13, which although not printed, is illustrated in dashed line for explanatory purposes.

In WO 01/126032, a 4×4 array of dots is described, and also a 6×6 array of dots, to define a cell. Each cell has its dots at a unique combination of positions in the pattern space so as to locate the cell in the pattern space. The dot pattern of an area of the dot pattern space codes for the position of that area in the overall dot pattern space. The contents of WO 01/126032 are hereby incorporated by reference.

The dots 14 may be read by a suitable reader and the position of the dots which are read may be determined in the pattern space of the pattern in a known manner. In the Anoto™ system a pen may be used as the reader. Such pens exist today and available from Anoto™ as the Logitech IO™ pen and Hewlett-Packard™ as the HP digital pen 2000.

As described above, in a known method of printing digital pattern document, a bitmap representation of the pattern, which in the case of the Anoto™ pattern is made up of dots 14, is transmitted to a printer for printing. Due to the large resultant print file sizes, file handling, transmission and printing speed problems may arise.

In the present embodiment metadata referencing the portion of the pattern to be printed is transmitted to the printer instead of a graphical description of the pattern, such as a bitmap. At the printer, the metadata may be used to reconstruct an image of the portion of pattern so that it may be printed. The image may be reconstructed in the form of a bitmap for example. This process allows the sizes of files that are sent to the printer to be significantly smaller than would otherwise be the case.

The concept of metadata being used to describe location pattern will now be described with reference to FIG. 2.

In the Anoto™ system each dot 14 is offset from its nominal position in one of four directions, so an area of pattern having a given number of dots has a corresponding number of possible combinations of dot layouts, or configurations. For example, in an area having a single dot 14, that dot may be located in any one of four possible positions relative its nominal position; i.e. that area has four possible dot configurations. Or, for example, in an area having four dots 14, there are 4⁴, or 256 possible dot locations configurations.

FIG. 2 illustrates a 4 by 4 array of dots 14 of Anoto™ digital pattern (or position location pattern) having the same dot configuration as that illustrated in FIG. 1. As can be seen from the figure, the 16 dots 14 have been grouped in four separate groups labelled A-D. In this example, each of the four separate groups A-D is a 2 by 2 array of dots. Each of the groups A-D has a different configuration of dots; i.e. each of the groups A-D corresponds to a different one of the 256 possible configurations of dots for a 2 by 2 dots array.

It will be understood that each of the 256 possible configurations of dots for a 2 by 2 dots array maybe unambiguously characterised by a reference code, or metadata. In the present embodiment, these 256 configurations are each referenced by different binary reference codes. Since there are 256 different dot configurations, an 8 bit binary string is sufficient to allow each of the 256 dot configurations to be unambiguously identified.

It will also be understood that the dots 14 making up areas of location pattern larger than that shown in FIG. 2 may be divided up or grouped into such 2 by 2 arrays of dots, and characterised using metadata in this way.

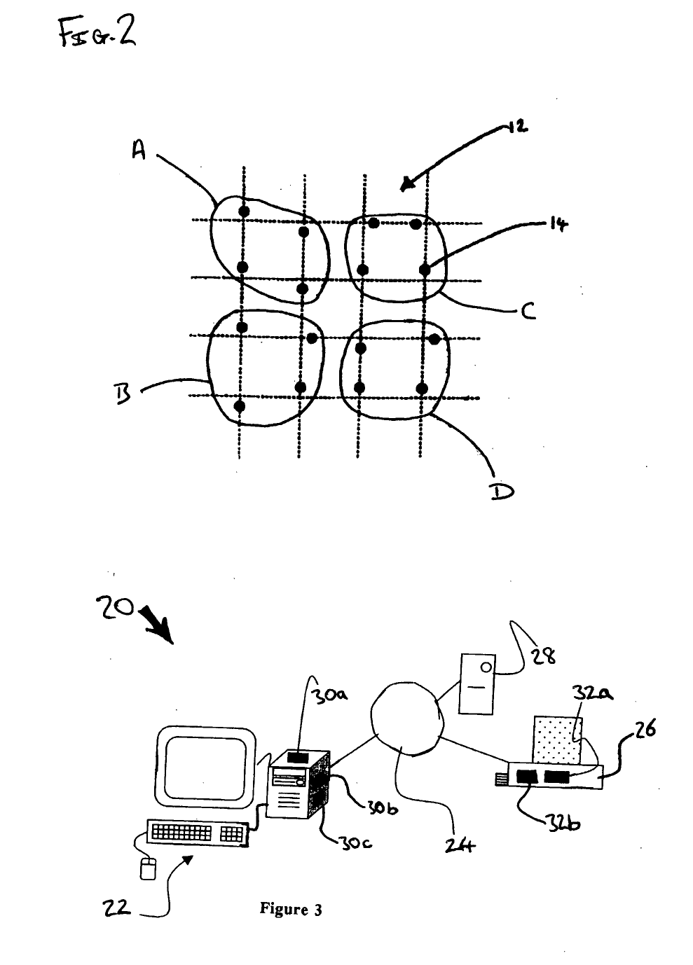

Referring to FIG. 3, an exemplary system 20 arranged to implement the present embodiment is schematically illustrated. The figure illustrates a PC 22 together with a user input device, such as a keyboard or a mouse, and a display or screen. The PC 22 is connected via a conventional network 24 to a location pattern allocation server 28 and a printer 26. The printer 26 is one capable of printing the dot position pattern to a satisfactory quality and may be a high resolution (600 or 1200 dpi) laser jet printer for example.

The PC 22 has various software applications loaded on it. These include amongst others: a printer driver 30a; a form design tool (FDT) 30b; and, a print on demand tool (PDT) 30c. The printer 26 has associated with it a print file interpreter 32a and one or more font definition files 32b. The functions of these applications and files are discussed in more detail below.

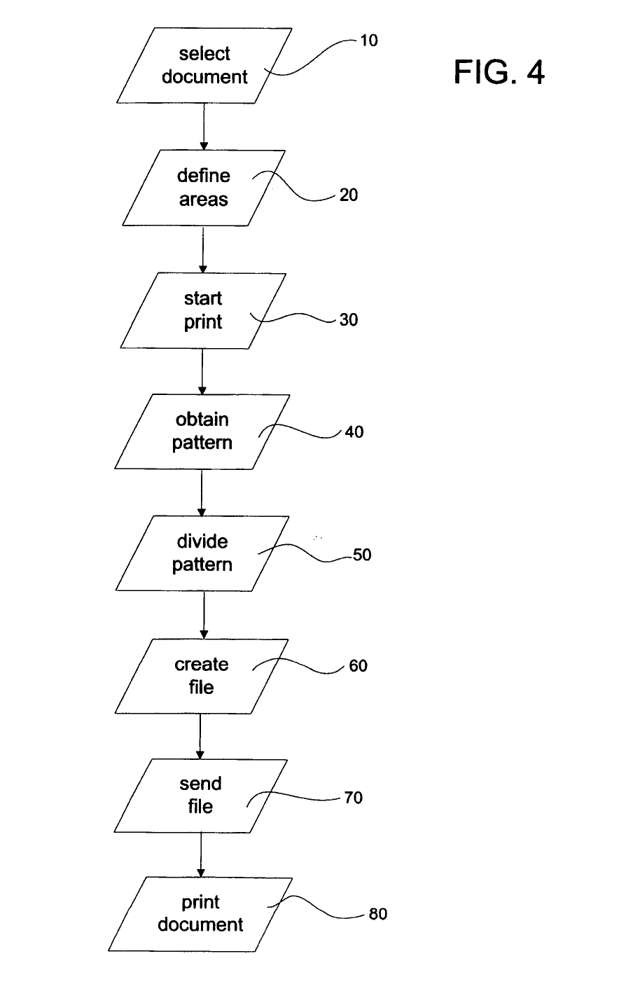

The method of operation of the present embodiment will now be described with respect to the flow diagram illustrated in FIG. 4.

At step 10, the user of the PC 22, selects a document that he wishes to print with position location pattern. This could be a pre-prepared document, such as a form, selected from the memory of the PC 22 in a conventional manner. Instead, the user could create a document for this purpose. In either event, the document may be in a conventional format, such as PDF or a Microsoft Word format, created using conventional applications. Alternatively, the user may choose to print a “blank” document, for example a single A4 page. In this case, in the present embodiment, the document may be printed with location pattern but with no user readable content.

At step 20, the areas of the document to which the location pattern are to be applied are defined. This may be achieved by the user using the software form design application or tool (FDT) 30b. In the present embodiment this is in the form of an Adobe Acrobat™ 5.0 plug-in. The content (or blank document) is therefore converted to PDF format and the pattern areas defined by the user using the FDT 30b. This yields a PDF format document defining both the content and the positions and shapes of the position pattern areas. The user may save this document locally on the PC 22 in the normal manner. In a simple embodiment, digital pattern may be allocated to the entire area of each page of the document automatically by the FDT 30b, in a manner that is transparent to the user.

At step 30, the user initiates a printing operation in which the selected document is printed. The user may achieve this by opening the digital document and selecting a printing option. This causes the print on demand tool (PDT) 30c to open a printing user interface (UI). In the present embodiment the PDT 30c may be in the form of an Adobe Acrobat™ 5.0 plug-in. Using the printing UI the user requests the required number of prints (and any other required printing parameters) and initiates the actual printing operation by inputting a print command via the printing UI.

When the printing process is initiated, the PDT 30c obtains the required amount of pattern area for the job in hand at step 40. In one embodiment, the PDT 30c requests the pattern area from the pattern allocation server 28. In this case the PDT 30c may take the form of software in a printer filter driver within the PC 22.

The PDT 30c subsequently receives a definition of the allocated pattern space from the pattern allocation server 28. This can be, for example, defined in terms of co-ordinate references within the total pattern space, from which the PDT 30c may generate the required details of the allocated pattern space. This may mean generating a bitmap of the allocated pattern space. Alternatively, it may mean generating a mathematical description of any one or more of the shape, size and position of the elements which it comprises; i.e. the dots 14 in the case of the Anoto™ pattern. The definition of the allocated pattern space received from the pattern allocation server 28 could instead be a full definition of the actual pattern to be used, such as a bitmap.

In a simpler, alternative embodiment the entire position location pattern may be stored, in a conventional manner, locally to the PC 22. In this case, the PDT 30c merely identifies a suitable, available area of pattern for use with the current print job.

The PDT 30c then divides up the allocated pattern area in the required manner to fit the pattern areas on the document, should this be required, at step 50.

The processes of digital form design and allocating pattern area from a store for printing on a document may vary in many ways. One way in which these processes may be implemented in embodiments of the present invention is described more fully in co-pending British patent application number 0321172.9, filed on 10 Sep. 2003 and entitled: Creation of documents with position identification pattern; HP reference 200310131-1, which is hereby incorporated in its entirety by reference.

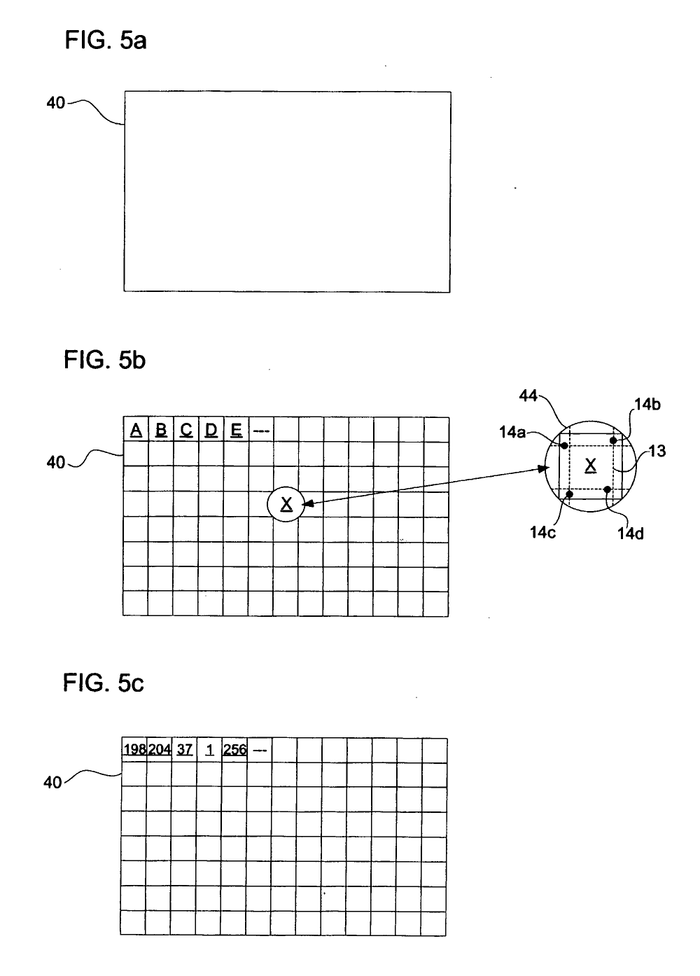

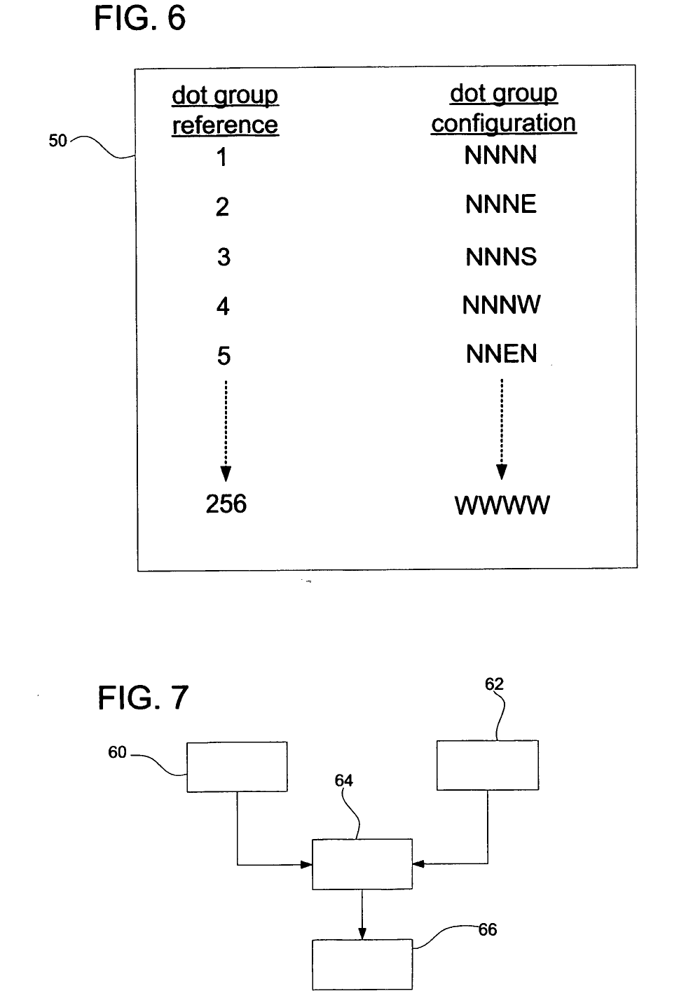

At step 60, a print file for printing the selected document together with the allocated pattern is generated. The process for doing so in the present embodiment is schematically illustrated in FIGS. 5a-c and FIGS. 6 to 8.

FIGS. 5a-c, are enlarged, schematic illustrations of an area of digital pattern which has been allocated to be printed with the selected document of the present example. These figures illustrate in a schematic manner certain process steps performed on the digital pattern in the method of the present embodiment.

FIG. 5a illustrates in outline the allocated area of digital pattern 40. For ease of explanation, the pattern area 40 is illustrated as the area that the pattern might cover on a document when printed. It will, of course, be appreciated that in practise this pattern will normally be held in memory of the PC 22 in a conventional format. As can be seen from the figure, the pattern area 40 is a single, rectangular shape that covers only a relatively small area of the page. Such an area of pattern might be printed throughout a checkbox on a printed form, for example. Each of the size, shape and number of areas of digital pattern that may be printed within a selected document may vary in any convenient manner.

The area of digital pattern 40 is analysed by the PDT 30c to determine the distribution of the dots 14 contained in the area 40 and to logically group the dots 14 into groups. In the present embodiment, the PDT 30c groups the dots into arrays, each composed of a 2 by 2 arrangement of dots, as in the manner illustrated in FIG. 2.

After this grouping process is implemented, the area of digital pattern 40 may be envisaged as is illustrated in FIG. 5b. In this figure, the square grid 42 overlying the area 40 provides a visual schematic of the boundaries between adjacent groups (or 2 by 2 arrays) of dots 14. The square grid 42 is made up of smaller cells of which the first five in the top row from left to right have been labelled “A”-“E”. Thus, each of these cells (A-E etc.) represents a 2 by 2 arrays of dots 14. This is more clearly illustrated in the enlarged portion 44 of the figure. This schematically illustrates an exemplary configuration of the 2 by 2 array of dots 14a-d present an exemplary cell “X” in the area 40. In the enlarged portion 44 of the figure, the position of the dots 14a-d with respect to their nominal positions is illustrated. The nominal positions of the dots 14a-d are represented by the intersections of the dashed gridlines 13, which were described with reference to FIG. 1.

The PDT 30c then analyses, the configuration of dots in each of the cells (A-E etc.) in the area 40. This configuration may be termed the “dot group configuration”. This may be achieved in any convenient way. However, with an Anoto™ style pattern, it is convenient to do this by determining the dot offsets from their nominal positions for each of the four dots in each cell. That is to say, the PDT 30c determines for each of the groups of dots the position of each of the four dots making up that group relative to its nominal position. Taking for example the dots making up the group illustrated in enlarged portion 44: dot 14a is located to the left or west (W) of its nominal position; dot 14b is located above or north (N) of its nominal position; dot 14c is located below or south (S) of its nominal position; and, dot 14d is located to the left or west (W) of its nominal position. Thus, using one example nomenclature, the dot group configuration corresponding to that of the exemplary cell “X” is: west, north, south, west, or WNSW.

The PDT 30c then generates a reference or index for each determined dot group configuration. This reference may be termed the “dot group reference”. It is the dot group reference that is used as metadata to describe a given dot group in the present embodiment. In the present embodiment, the dot group reference is obtained from a look up table 50, which relates the determined dot configurations with their corresponding dot group references. The look up table 50 may be stored in any convenient form and any convenient location. Typically, this may be in memory associated with the PC 22.

FIG. 6 schematically illustrates such as look up table 50. As has been described above with reference to FIG. 2, each 2 by 2 array of dots, or each cell having four dots 14, may have any one of 4⁴, or 256, possible dot group configurations. Thus, as can be seen from FIG. 6, the values of the dot group references range from 1 to 256. Associated with each dot group reference is a different dot group configuration written in the notation used above. Thus, it will be understood that each of the 256 possible dot group configurations may be unambiguously referenced by a different dot group reference, or metadata. In the present embodiment, the dot group reference values are binary codes values. Since there are 256 different dot configurations, an 8 bit binary string is sufficient to allow each of the 256 dot group configurations to be unambiguously identified.

In the figure only the values 1-5 and 256 of the dot group reference are illustrated, together with their corresponding dot group configurations. Thus, for example, if each of the four dots in a given group are offset in a direction north of their nominal positions, the dot group configuration is “NNNN”. The corresponding dot group reference in this example is “1”. If three of the four dots, corresponding to dots 14a-c in the cell “X” of FIG. 5b, are offset in a direction north of their nominal positions and the dot corresponding to the dot 14d in the cell “X” is offset in a direction east of its nominal position, the dot group configuration is be shown as “NNNE”. The corresponding dot group reference in this example is “2”; and so on.

Once the dot group reference has been determined for each of the dot groups of the pattern area 40, each group has a reference, or metadata, associated with it. This is schematically illustrated in FIG. 5c, in which the cells A-E of the grid 42 are illustrated bearing the exemplary dot group references: 198; 204; 37; 1; and, 256, respectively.

The next sub-step in the file generation process of FIG. 4 is to merge the metadata, which is used to describe the position location pattern to be printed, with the selected document. In this manner, the position location pattern and the selected document may be printed superimposed as desired. As has been stated above, the document selected to be printed is at this stage stored as a PDF file. As such, it may be modified using conventional techniques to include extra data. In the present embodiment, the PDT 30c modifies this PDF file to incorporate the metadata in the form of conventional font information. This process is illustrated in FIG. 7, where the selected document file 60 and the metadata 62 are shown being merged to give rise to a modified selected document file 64.

The PDT 30c then passes the modified selected document file 64 to the printer driver 30a resident on the PC 22. The printer driver 30a then converts the modified selected document file 64 into a language which may be understood by the printer 26, such that the file may be printed. This language may be any convenient language such as a conventional page description language (PDL); for example PCL5 or PostScript. In this example, the PDL version of this file is referenced 66 in the figure.

In other embodiments, this conversion may happen when the metadata and the document content are merged, in step 64. Indeed in other embodiments, the operation of the PDT 30c may be limited to converting the selected document to PDL format and passing this converted file to the printer driver. In such an embodiment, the printer driver 30a may be responsible for all of the steps 40 through to 70 of FIG. 4. Conveniently, the printer driver 30a may carry out all of those steps in PDL format.

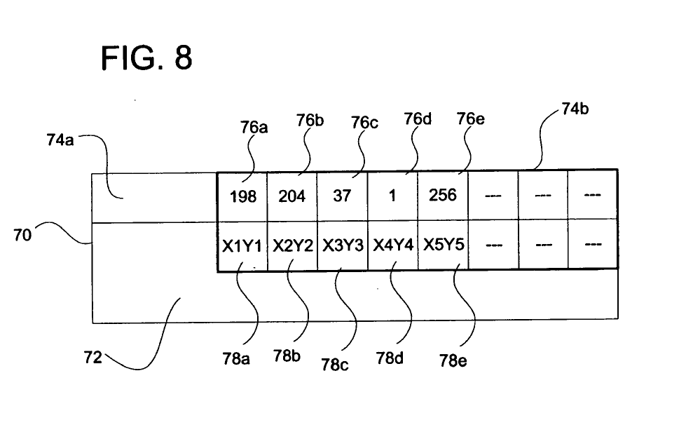

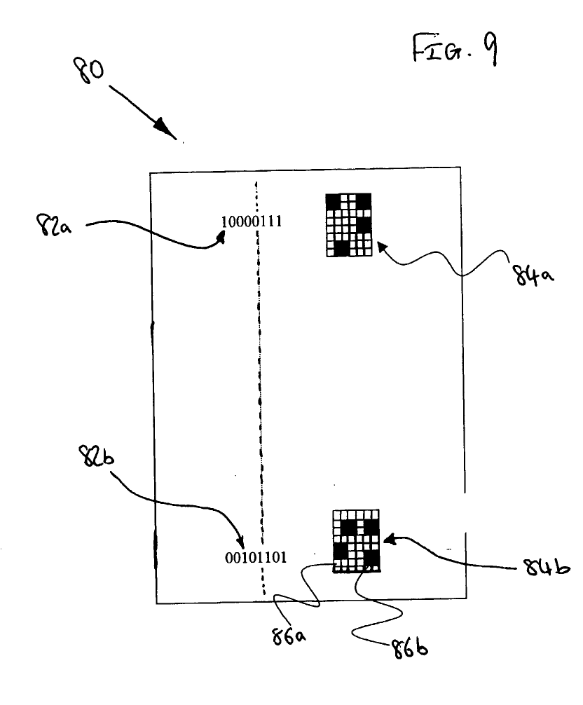

FIG. 8 schematically illustrates the resultant PDL file 70. As can be seen from the figure, the file 70 contains a content portion 72, an instruction portion 74a and a fonts portion 74b.

The content portion 72 contains the human readable portion of the document to be printed. This content may be made up of, for example: a form; an image; or, other human readable content. This content may be held in any suitable format such as vector, image or text. As has been stated above, in some cases, no content is printed. In such cases, this portion of the file may be empty or omitted.

The fonts portion 74b holds font information. In FIG. 8, the font information is illustrated by boxes 76 and 78. The boxes 76a-e each represent a binary value which corresponds to a given font character in the specified “location pattern font”, of which the font definition file 32b (illustrated in FIG. 3) is resident upon the printer 26. For ease of reference, these binary values are illustrated in the figure as decimal values. Their values are: 198, 204, 37, 1 and 256, respectively. It will be seen that these values are the dot group reference values discussed with reference to FIG. 5c. In particular, these values are the same as those in the first five cells of the first row (going from left to right) of the pattern area 40 shown in FIG. 5c. Thus, in the present embodiment, the font portion of the file 70 includes the dot group reference value of each of the cells (or, corresponding to each of the dot groups) of the area 40 in FIG. 5c. Thus, whilst in the figure only boxes 76a-e are shown, it will be understood that in practice any reasonable number of font characters may be specified in a file such as that illustrated in FIG. 8.

These dot group reference values may be stored in any convenient structure. For example, their binary values may be simply concatenated in a conventional manner. As is conventional, the first font character to be printed in a given row may be preceded, for example, by co-ordinates (not shown in the figure) in the geometry of the document to be printed. These co-ordinates may be used to position this font character. Font characters corresponding to the following dot group reference values may be printed in the same row as the first font character in sequentially adjacent positions.

It will be understood that font characters in the present embodiment may be laid out on the printed page with no overlap and no blank space between font characters adjacent to one another in either the horizontal or vertical direction. Thus, any pixel on the document may be accessed or printed using font characters in the present embodiment. In this manner, the position of the pixels making up individual dots 14 of the position location pattern is unconstrained within the limitations of the resolution of the printer 26, in the present embodiment.

In the present embodiment, an alternative method of designating the printed position of font characters may additionally or instead be used. The boxes 78 each represent co-ordinate values. Each co-ordinate value may be used to define the placement of a corresponding font character. This placement may be defined in the co-ordinate geometry of the document to be printed, for example. Thus, the contents (X₁Y₁) of the box 78a may define the placement of the font character of the box 76a in the document. In one method, the values of the co-ordinates X₁Y₁ may define the position of the top left-hand point of the font character defined by the value 198 in the box 76a. This may be a useful manner of stipulating that one or more font characters should be printed in an overlapping manner should this be required.

The instruction portion 74a shown in FIG. 8 provides information required by the printer in order to correctly merge the human readable contents 72 with the font information 74b. This may include transparency information, that is to say the transparency values that should be applied to the various objects to be printed. This may also include order information, that is to say the order in which the various objects to be printed are overlapped when being rendered. Furthermore, the instruction portion 74a in the present embodiment stipulates the identity of the font definition file should be employed at the printer when interpreting font information contained in the font portion 74b of the file 70. In the present embodiment, this is the font definition file 32b for the specified “location pattern font”.

Referring once again to FIG. 4, when the PDL file 70 is prepared, it is transmitted from the PC 22 to the printer 26 over the network 24, at step 70.

At step 80, the printer 26 prints the received print job. In the present embodiment, this is carried out in generally conventional manner. However, this process is nevertheless described briefly below.

The printer 26 contains a conventional print file interpreter 32a (illustrated in FIG. 3) that processes the PDL file 70 file in a conventional manner. In this process, it analyses the PDL file 70 to determine its contents. The interpreter 32a renders the components of the PDL file into a format ready for printing, for example one or more planes of print data.

It will be understood that in the present embodiment, the interpreter 32a may interpret any human readable content 72 that the file may contain in a conventional manner. When interpreting the font data that defines the location pattern, the interpreter sequentially reads successive 8 bit strings in the portion of the file 70, corresponding to the boxes 76a-e etc. It will be recalled that each 8 bit string is a dot group reference that identifies a given font character in the specified “location pattern font”, resident upon the printer 26. The interpreter 32a then locates the required dot group references in the font definition file 32b for the specified “location pattern font”. Associated with each dot group reference in the font definition file 32b is a corresponding different font character definition. In the present embodiment, the font character definitions are stored as bitmaps.

A partial example of a font definition file 80 for the specified “location pattern font” of the present embodiment is schematically illustrated in FIG. 9. As can be seen from the figure, two dot group references 82a, 82b are illustrated. In the figure both of the dot group references 82a, 82b are illustrated in the form of an 8 bit binary code. A single font character 84a, 84b is associated with each dot group references 82a, 82b. The font characters 84a, 84b each illustrate a different one of the 256 possible dot group configurations. Although only two font characters 84a, 84b are illustrated in the figure, it will be understood that in the present embodiment the full font definition file 32b for the specified “location pattern font” contains sufficient font characters in order to print all of the required dot group configurations. In this embodiment, as has been discussed above, there are 256 possible combinations of dot locations and a corresponding 256 different font characters.

Although, the font characters 84a, 84b are stored in bitmap form in the present embodiment, any other type of font could instead or additionally be used. As can be seen from the figure, the bitmap font characters 84a, 84b are each composed of a 6 by 8 grid of pixels 86a, 86b. However, font characters having other sizes (in terms of pixel numbers) and shapes may also or instead be used.

Once the printer interpreter 32a has determined an individual font character bitmap to be printed, its print location in terms of the co-ordinate geometry of the document is determined. This may be achieved in any convenient manner, such as one of the ways describe above. This bitmap information is then saved to a suitable location of printer memory in a conventional manner. This process is then repeated for all of the font data held in the file 70. At this stage, all of the font data in the file 70, describing every area of location pattern within the document have been processed.

The printer 26 then merges the processed content element of the PDL file 70 with the positioned bitmaps of the font characters. This may be achieved in a conventional manner, for example using an “or” function. In the present embodiment, pixels 86b making up the dots 14 in the font character bitmaps 84 may be printed with maximum print opacity. Conversely, the pixels 86a in the font character bitmaps 84 that do not make up the dots 14 may be printed with a maximum print transparency. In this manner, high contrast between areas defining the dots 14 and the adjacent areas may be achieved and so the dot pattern may easily be read by a pattern reader.

The printer 26 then prints the document onto a medium, for example a piece of paper, also in a conventional manner. In this manner a printed document containing on or more areas of position location pattern and possible some user readable content is generated.

### Other Embodiments

In the above description numerous specific details are set forth in order to provide a thorough understanding of the present invention. It will be apparent however to one skilled in the art that the present invention may be practiced without limitation to these specific details. In other instances, well known methods and structures have not been described in detail so as not to unnecessarily obscure the present invention.

For example, in the above described embodiment the portion of the position location pattern was generated and printed at the printer 26 from received metadata. In other embodiments of the invention the pattern is not printed however. For example, the portion of the pattern may be generated and then stored electronically. This may be for the purposes of displaying it on a screen, such as that of a tablet PC for example. A pattern displayed in this manner may be read by a “pen” (or other sensor) in a similar manner to that in which the Logitech IO™ pen reads the printed Anoto™ pattern. Alternatively, even if such generated pattern portions are destined to be printed eventually, embodiments of the present invention may be employed in transferring portions of digital patterns between two or more computing devices, prior to the step of transferring the patter, or metadata describing it to a further device (or printer) for printing. In one such embodiment a pattern allocation server (such as server 28 in the above embodiment) transfers metadata describing a required portion of pattern to a PC via a network. The pattern may then be reconstructed at the PC using the same or a similar method to that employed by the printer 26 in the above embodiment. At the PC, the pattern may be passed to a printer for printing, either in its reconstructed form or once again as metadata, it may be displayed on a screen, as mentioned above, or it may be processed in some other manner. In this embodiment, it is not necessary to store either a pattern generating algorithm at the PC or full knowledge of the pattern.

Furthermore, although in the embodiment described above, areas of the allocated pattern were printed as “font characters”, it will be understood that the use of fonts in the conventional sense of the word is not essential to the invention. Furthermore, in some embodiments, such terminology may not be appropriate and may be misleading. For example, in the case mentioned in the paragraph above where metadata is received by a PC and used to reconstruct digital pattern at that PC, the processes, protocols and data structures and formats employed may be developed in a custom or proprietary manner. In such a situation no use may be made of processes, protocols, data structures and formats used in fonts.

In such cases, the metadata used may describe elements or groups of elements of digital pattern that do not resemble fonts. For example, a page of digital pattern may be reconstructed from a number entire rows of pattern. Thus, each transmitted metadata code may reference a pattern portion such as a row that spans the entire page of a document. Such rows could have any reasonable height; for example between one pixel in height and the height of many conventional rows of text. As a further example, each transmitted metadata code may reference a portion of dispersed pattern elements. In this manner, many such dispersed patterns of pattern elements may overlap, or cover similar areas of the document or page. In one extreme example, each transmitted metadata code may reference a group of pattern elements that is so dispersed that it extends substantially over the entire area of a document. Such a group may comprise only a proportion of the required pattern elements. Thus, various or even a great many such groups may need to be superimposed in order to generate the full pattern.

From the above, it will be understood that the area of pattern which is referenced by a given metadata code need not be a 2 by 2 array of dots as described in the above-embodiment. This is of course the case even if fonts processed are used in the printing of such a pattern. If a regular array of points or pixels is employed, it need not be a square array. It may be rectangular for example, or indeed any other convenient shape. This might be any shape that is self-tessellating; such as rectangles or triangles for example. Clearly, the size of such arrays may also be larger or smaller than the examples given above. Furthermore, it will also be appreciated that in other embodiments, a portion of pattern may be broken down in to arrays or areas of different shapes and/or different sizes. This may be useful when the size of such areas is relatively large in relation to the size of the portion of pattern to be printed. Indeed in other embodiments, a portion of pattern may be broken down in to arrays which at least partially overlap.

Whilst the above example has dealt with the printing of an Anoto™ style pattern, it will be appreciated that other digital patterns may be printed or generated in this manner. For example, patterns composed at least in part of “data-glyphs” lend themselves well to embodiments of the invention. A data-glyph is understood to be a basic graphical element which can encode at least some information. Generally, therefore, a data glyph has characteristics that are more complex than an individual dot, taken in isolation, of the Anoto™ style pattern. Typically these complexities lie in the form or shape of the data glyph. Such complexities allow information, generally relating to the functioning of the pattern, to be encoded in the individual element. WO 00/73983 and WO 01/71643 disclose some examples of patterns that may be printed or generated in embodiments of the present invention.

In the above-described embodiment, the printer 26 was described as having one or more font definition files 32b. In some embodiments of the invention, two or more of these font definition files may be for printing position location pattern. In this manner, a given printer may be arranged to print documents bearing different position location patterns. It will of course be appreciated that such a printer may also contain font definition files relating to normal human readable fonts.

In the above-described embodiment, an 8 bit code was used to reference each of the dot group configurations. It will be appreciated that in other embodiments this may be varied to suit the requirements of the embodiment of the invention. It will be appreciated that, in general, if the location of each dot 14 can be described with two bits, an n-bit font can be used to describe all the possible location combinations of n/2 dots. For example in a Unicode, double byte, font, there are 65,536 characters described by 16 bits. This means that such a font may describe all of the possible location combinations of 8 dots.

In the above embodiment the metadata which is passed from the PC to the printer (i.e. the dot group references) is essentially a series of arbitrary codes, despite the fact that the codes have predetermined relationships with the dot group configuration values. In other embodiments, the metadata which is passed, to the printer for example, may not be arbitrary. For example, it may positively define the positions of the dots in a group. In this sense, it could be viewed as information which directly conveys or codes the dot group configuration (such as NNNN, for example). In this case, an interpreter located at the printer would be configured to recognise the values of the metadata defining the dot configurations of the dot groups directly from the metadata. One advantage of using metadata which directly defines a dot group's dot configuration is that it is not required to ensure that reference values located at both the printer and the PC are synchronised.

In other embodiments of the invention, a portion of a digital pattern may be sent as metadata, as described above, together with a file defining the fonts that should be used, in conjunction with the metadata, to reconstruct the portion of a digital pattern; i.e. with the font definition file. This receiving apparatus, such as a printer, may store the recently received font definition file in memory in a conventional manner. The recently received font definition file may then be used to reconstruct the digital pattern as described above. In this manner, a file may be sent to a receiving device such as a printer or a PC which does not yet have installed the appropriate font definition file.

1. A method of generating an area of location pattern, the area comprising a plurality of sub-areas, the method comprising:
for each of the sub-areas, determining (a) metadata identifying the sub-area, and (b) the position of the sub-area relative to the area;
transmitting to a receiving device (a) and (b) for each of the sub-areas;
retrieving from memory, associated with the receiving device, image information corresponding to the metadata, thereby generating in memory an image corresponding to the area of the pattern to be generated.

2. A method according to claim 1, further comprising the prior step of dividing the area into the plurality of sub-areas.

3. A method according to claim 1, wherein the step of determining metadata identifying the sub-areas comprises matching a given sub-area to a corresponding sub-area in a store of sub-areas and identifying corresponding metadata from the store.

4. A method according to claim 1, further comprising the step of ordering the metadata identifying the sub-areas, the order of the metadata being indicative of the relative position of the sub-areas in the area.

5. A method according to claim 1, wherein the metadata is arranged serially.

6. A method according to claim 1, wherein the step of transmitting comprises transmitting further information comprising the relative positions of the sub-areas to which the metadata relates.

7. A method according to claim 1, wherein the step of retrieving comprises matching received metadata corresponding to a given sub-area with corresponding metadata stored in a store associated with the receiving device, and retrieving image information associated with the stored corresponding metadata.

8. A method according to claim 1, wherein the receiving device is a printer device.

9. A method according to claim 8, wherein the printer device is adapted to retrieve image information corresponding to a given sub-area in the form of font information.

10. A method according to claim 9, wherein the image information is stored in a form of a font definition file.

11. The method of claim 5 comprising generating the font in the form of a TrueType font or a bitmap font.

12. (canceled)

13. A computer program comprising program code means for performing the method steps of claim 1 when the program is run on a computer and/or other processing means associated with suitable apparatus.

14. (canceled)

15. A method of printing position location pattern on demand, upon a medium, comprising the steps of:
sub-dividing a portion of position location pattern into a plurality of components;
determining which of a plurality of characters of a font corresponds to each component;
generating a data string comprising identifiers corresponding to each of said characters;
transmitting said data string to an output device; and
using said data string in the control of the output of the portion of position location pattern upon the medium.
